(19) United States
(12) Patent Application Publication
(10) Pub. No.: US 2025/0348416 A1
(43) Pub. Date: Nov. 13, 2025

(54) System and Method for Software Performance Regression Detection and Reporting

(71) Applicant: Dell Products L.P., Round Rock, TX (US)

(72) Inventors: David Alexander Kaufman, Beer-Sheva (IL); Lev Makler, Beer-Sheva (IL); Michael Timmy Opachevsky, Eilat (IL); Orel Revach, Dimona (IL); Sean Shimon Assolin, Dimona (IL)

(21) Appl. No.: 18/662,789

(22) Filed: May 13, 2024

(51) Int. Cl. G06F 11/36

(52) U.S. Cl. CPC G06F 11/3684

(57) ABSTRACT

A method and system for software performance regression testing and reporting. A plurality of tests are conducted on a test configuration. Results of each of the plurality of tests are analyzed to render a validity determination for each of the plurality of tests. Based on the validity determinations, a subsequent test to conduct on the test configuration is determined. The subsequent test is conducted on the test configuration, thereby generating a plurality of test results, and the plurality of test results are clustered. Test results deviating from an expected test result are identified based on a deviation threshold, resulting in at least one regression from the expected test result. The test configuration is retested to confirm the occurrence of the at least one regression.

### BACKGROUND

The fast-moving nature of software development can pose a significant challenge when it comes to comprehensive testing, as there can be numerous versions and modifications that require testing to meet reliability and functionality expectations. Meeting the necessary test coverage for an exit-criteria is critical, and it heavily relies on test configurations that can produce the most precise and relevant results. Detecting performance regressions between software versions can pose a significant challenge. Performance is quantified through metrics like IOPS and latency, and their inherent variability makes it difficult to accurately detect and report bugs and regressions. Typically, varying test results, once obtained, must be manually compared to each other to determine regressions related to a particular test configuration, which is inefficient, time consuming, and prone to error.

### SUMMARY OF DISCLOSURE

In one example implementation, a computer-implemented method comprises conducting a plurality of tests on a test configuration; analyzing results of each of the plurality of tests to render a validity determination for each of the plurality of tests; based on the validity determinations, determining a subsequent test to conduct on the test configuration; conducting the subsequent test on the test configuration, thereby generating a plurality of test results; clustering the plurality of test results; identifying test results deviating from an expected test result based on a deviation threshold, resulting in at least one regression from the expected test result; and retesting the test configuration to confirm the occurrence of the at least one regression.

One or more of the following example features may be included. The subsequent test may be determined based on a number of valid test results compared to a total number of tests performed. The method may further include utilizing the at least one regression to determine the subsequent test. The method may further include generating a report of test results, comparing each of the test results to an expected test result to determine acceptable test results, and predicting behavior of the plurality of tests based on clustering patterns.

In another example implementation, a computing system includes a memory, a computing environment including a plurality of interconnected computing devices, and a processor to conduct a plurality of tests on a test configuration; analyze results of each of the plurality of tests to render a validity determination for each of the plurality of tests; based on the validity determinations, determine a subsequent test to conduct on the test configuration; conduct the subsequent test on the test configuration, thereby generating a plurality of test results; cluster the plurality of test results; identify test results deviating from an expected test result based on a deviation threshold, resulting in at least one regression from the expected test result; and retest the test configuration to confirm the occurrence of the at least one regression.

One or more of the following example features may be included. The subsequent test may be determined based on a number of valid test results compared to a total number of tests performed. The method may further include utilizing the at least one regression to determine the subsequent test. The method may further include generating a report of test results, comparing each of the test results to an expected test result to determine acceptable test results, and predicting behavior of the plurality of tests based on clustering patterns.

In another example implementation a computer program product residing on a non-transitory computer readable medium having a plurality of instructions stored thereon which, when executed by a processor, cause the processor to perform operations including conducting a plurality of tests on a test configuration; analyzing results of each of the plurality of tests to render a validity determination for each of the plurality of tests; based on the validity determinations, determining a subsequent test to conduct on the test configuration; conducting the subsequent test on the test configuration, thereby generating a plurality of test results; clustering the plurality of test results; identifying test results deviating from an expected test result based on a deviation threshold, resulting in at least one regression from the expected test result; and retesting the test configuration to confirm the occurrence of the at least one regression.

One or more of the following example features may be included. The subsequent test may be determined based on a number of valid test results compared to a total number of tests performed. The method may further include utilizing the at least one regression to determine the subsequent test. The method may further include generating a report of test results, comparing each of the test results to an expected test result to determine acceptable test results, and predicting behavior of the plurality of tests based on clustering patterns.

The details of one or more example implementations are set forth in the accompanying drawings and the description below. Other possible example features and/or possible example advantages will become apparent from the description, the drawings, and the claims. Some implementations may not have those possible example features and/or possible example advantages, and such possible example features and/or possible example advantages may not necessarily be required of some implementations.

### BRIEF DESCRIPTION OF THE DRAWINGS

FIG. 1 is an example diagrammatic view of a storage system and a database integrity maintenance process coupled to a distributed computing network according to one or more example implementations of the disclosure;

FIG. 2 is an example depiction of a system for software performance regression detection and reporting according to one or more example implementations of the disclosure;

FIG. 3 is an example flowchart of the process for software performance regression detection and reporting according to one or more example implementations of the disclosure;

FIG. 4 is an example depiction of a graph showing clustering of test results; and

FIG. 5 is another example depiction of a graph showing clustering of test results.

Like reference symbols in the various drawings indicate like elements.

### DETAILED DESCRIPTION

### System Overview:

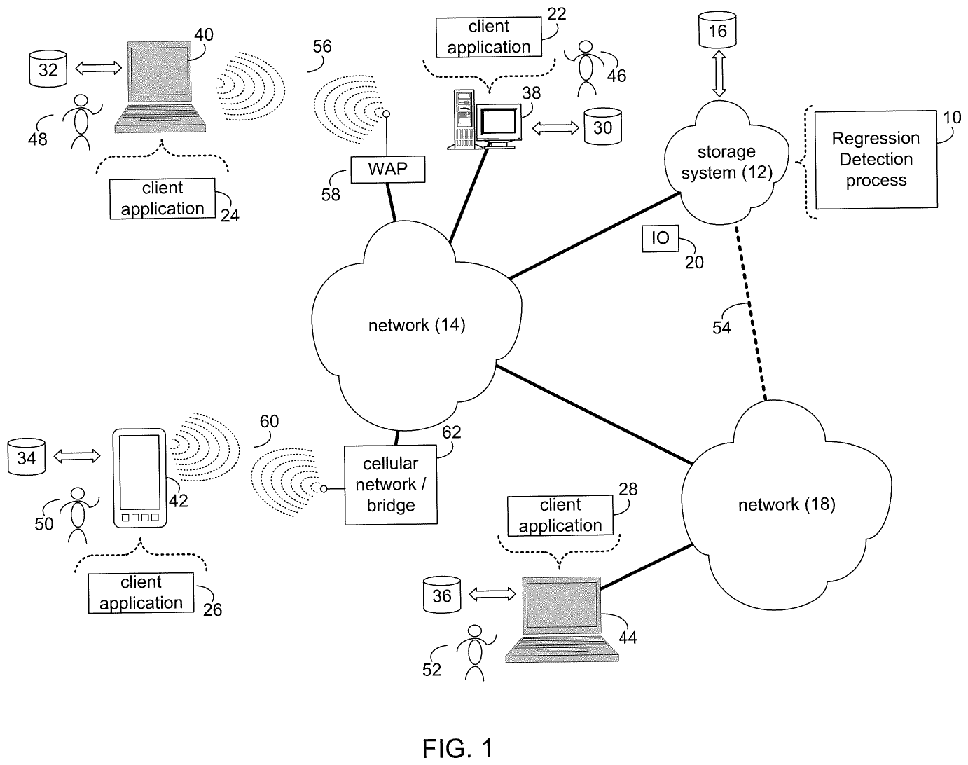

Referring to FIG. 1, there is shown regression detection process 10 that may reside on and may be executed by storage system 12, which may be connected to network 14 (e.g., the Internet or a local area network). Examples of storage system 12 may include, but are not limited to: a Network Attached Storage (NAS) system, a Storage Area Network (SAN), a personal computer with a memory system, a server computer with a memory system, and a cloud-based device with a memory system.

As is known in the art, a SAN may include one or more of a personal computer, a server computer, a series of server computers, a mini computer, a mainframe computer, a RAID device and a NAS system. The various components of storage system 12 may execute one or more operating systems, examples of which may include but are not limited to: Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

The instruction sets and subroutines of disability access assistance process 10, which may be stored on storage device 16 included within storage system 12, may be executed by one or more processors (not shown) and one or more memory architectures (not shown) included within storage system 12. Storage device 16 may include but is not limited to: a hard disk drive; a tape drive; an optical drive; a RAID device; a random access memory (RAM); a read-only memory (ROM); and all forms of flash memory storage devices. Additionally/alternatively, some portions of the instruction sets and subroutines of disability access assistance process 10 may be stored on storage devices (and/or executed by processors and memory architectures) that are external to storage system 12.

Network 14 may be connected to one or more secondary networks (e.g., network 18), examples of which may include but are not limited to: a local area network; a wide area network; or an intranet, for example.

Various IO requests (e.g. IO request 20) may be sent from client applications 22, 24, 26, 28 to storage system 12. Examples of IO request 20 may include but are not limited to data write requests (e.g., a request that content be written to storage system 12) and data read requests (e.g., a request that content be read from storage system 12).

The instruction sets and subroutines of client applications 22, 24, 26, 28, which may be stored on storage devices 30, 32, 34, 36 (respectively) coupled to client electronic devices 38, 40, 42, 44 (respectively), may be executed by one or more processors (not shown) and one or more memory architectures (not shown) incorporated into client electronic devices 38, 40, 42, 44 (respectively). Storage devices 30, 32, 34, 36 may include but are not limited to: hard disk drives; tape drives; optical drives; RAID devices; random access memories (RAM); read-only memories (ROM), and all forms of flash memory storage devices. Examples of client electronic devices 38, 40, 42, 44 may include, but are not limited to, personal computer 38, laptop computer 40, smartphone 42, notebook computer 44, a server (not shown), a data-enabled, cellular telephone (not shown), and a dedicated network device (not shown).

Users 46, 48, 50, 52 may access storage system 12 directly through network 14 or through secondary network 18. Further, storage system 12 may be connected to network 14 through secondary network 18, as illustrated with link line 54.

The various client electronic devices may be directly or indirectly coupled to network 14 (or network 18). For example, personal computer 38 is shown directly coupled to network 14 via a hardwired network connection. Further, notebook computer 44 is shown directly coupled to network 18 via a hardwired network connection. Laptop computer 40 is shown wirelessly coupled to network 14 via wireless communication channel 56 established between laptop computer 40 and wireless access point (e.g., WAP) 58, which is shown directly coupled to network 14. WAP 58 may be, for example, an IEEE 802.11a, 802.11b, 802.11g, 802.11n, Wi-Fi, and/or Bluetooth device that is capable of establishing wireless communication channel 56 between laptop computer 40 and WAP 58. Smartphone 42 is shown wirelessly coupled to network 14 via wireless communication channel 60 established between smartphone 42 and cellular network/bridge 62, which is shown directly coupled to network 14.

Client electronic devices 38, 40, 42, 44 may each execute an operating system, examples of which may include but are not limited to Microsoft® Windows®; Mac® OS X®; Red Hat® Linux®, Windows® Mobile, Chrome OS, Blackberry OS, Fire OS, or a custom operating system. (Microsoft and Windows are registered trademarks of Microsoft Corporation in the United States, other countries or both; Mac and OS X are registered trademarks of Apple Inc. in the United States, other countries or both; Red Hat is a registered trademark of Red Hat Corporation in the United States, other countries or both; and Linux is a registered trademark of Linus Torvalds in the United States, other countries or both).

In some implementations, as will be discussed below in greater detail, a data deduplication process, such as virtual entry lifetime expansion process 10 of FIG. 1, may include but is not limited to, monitoring a deduplication function of a virtual layer of a data storage system, incrementing a reference count of a virtual entry when a data page is written to the virtual layer, decrementing the reference count of the virtual entry when a data page is deleted from the virtual layer, maintaining the virtual entry in the virtual layer when the reference count reaches a predetermined value, and reclaiming the virtual entry when a predetermined action of the data storage system is to be performed.

For example purposes only, storage system 12 will be described as being a network-based storage system that includes a plurality of electro-mechanical backend storage devices. However, this is for example purposes only and is not intended to be a limitation of this disclosure, as other configurations are possible and are considered to be within the scope of this disclosure.

### The Software Performance Regression Detection and Reporting System and Process

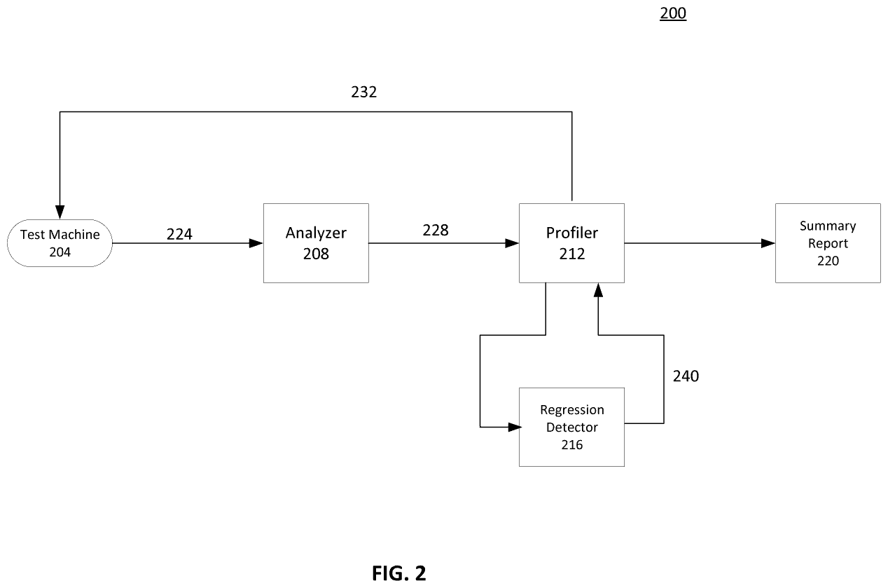

FIG. 2 is a graphical representation of a software performance regression detection and reporting system 200 according to an implementation of the disclosure. System 200 includes a test machine 204 for conducting software performance tests and an analyzer 208 for receiving test results 224 from the test machine 204 and analyzing the validity of the results to determine validity of each test. The validation results 228 from the analyzer are input to a profiler 212, which determines the next test that should be carried out on the test configuration to increase test coverage and minimize machine idle time. Profiler also compiles summary reports 220 of the validation results 228 received from the analyzer 208 for later review by testing personnel. A regression detector 216 also receives test results 236 from the profiler 212 and generates clusters of multiple test results for each test configuration to identify tests that deviate from expected results and therefore represent regressions. Data achieved from the clustering operation 240 is input to the profiler 212 to update the profiler 212 so that test configurations that include regressions can be retested.

Regression testing is a software testing technique used to ensure that recent changes or updates to a software application have not adversely affected its existing functionality. It involves retesting the previously tested parts of the software to detect any unintended side effects or regression defects that may have been introduced as a result of code changes, bug fixes, or system enhancements. The goal of regression testing is to verify that the software still behaves as expected after modifications, updates, or configuration changes, thereby maintaining its overall quality and reliability.

Regression testing typically involves the following steps:

1. Selection of test cases: Test cases that cover critical functionality, frequently used features, and areas of the software most likely to be affected by recent changes are selected for regression testing.

2. Execution of test cases: The selected test cases are executed against the modified version of the software to verify that the changes have not introduced any new defects or caused existing functionality to break.

3. Comparison of results: The results of the regression tests are compared with the expected outcomes or baseline results obtained from previous testing cycles. Any discrepancies or deviations from expected behavior are identified as regression defects.

4. Debugging and resolution: If regression defects are detected, they are logged, prioritized, and assigned to developers for resolution. The affected code is debugged, and necessary fixes are implemented to restore the correct behavior of the software.

Test machine 204 may be a dedicated computer or hardware environment specifically set up for the purpose of conducting software testing activities. Test machines are equipped with the necessary hardware and software configurations to support various testing tasks, including test execution, debugging, analysis, and reporting. These machines are isolated from production environments to prevent interference with live systems and to ensure that testing activities do not impact the stability or performance of production systems.

Test machine 204 may be configured to mimic the target environments where the software will ultimately be deployed, including operating systems, hardware specifications, network configurations, and other relevant parameters. This allows testers to validate the software's compatibility, functionality, and performance across different platforms and environments, ensuring that it meets the requirements and expectations of end-users. Depending on the complexity and scope of the software being tested, test machine 204 may comprise a single test machine or multiple test machines configured in a distributed or parallel testing environment. Distributed testing allows for the simultaneous execution of tests across multiple machines, speeding up the testing process and increasing test coverage.

Test machine 204 may be configured to carry out testing on a number of different test configurations. Test configurations refer to the specific combination of hardware, software, and environmental parameters used to conduct testing activities on a software application. Test configurations are designed to replicate the various environments in which the software will be deployed, including different operating systems, hardware platforms, network configurations, and software dependencies. Testing the software in diverse configurations can ensure that the software functions correctly and reliably across different environments and scenarios.

In implementations of the disclosure, test configurations include various configurations and scenarios that can have an impact of the software performance. Examples of different configurations include, but are not limited to, VdBench Performance (VDP) benchmarking, high availability (HA) events, e.g., simulations of failure scenarios, non-disruptive upgrade (NDU) scenarios, e.g., upgrades from old to new versions of software, and raid rebuilds, e.g., where data is reconstructed onto a replacement disk after a disk failure.

In various implementations, test configurations can include variations of the following components:

1. Operating System: The operating system (OS) on which the software will run. Testing the software on different operating systems helps identify and address compatibility issues and ensures that the software behaves consistently across platforms.

2. Hardware Platform: The hardware platform on which the software will be deployed, including processor architecture, memory, storage, and peripherals. Testing on different hardware configurations helps validate the software's performance, scalability, and resource utilization under varying conditions.

3. Software Dependencies: The software dependencies and libraries required by the application to function properly, such as database systems, web servers, middleware, or third-party APIs. Testing the software with different versions of dependencies helps ensure compatibility and interoperability with other software components.

4. Network Configuration: The network configuration, including network topology, bandwidth, latency, and security settings. Testing the software under different network conditions helps validate its performance, reliability, and security in real-world networking environments.

5. Environmental Factors: Other environmental factors that may impact the software's behavior, such as localization settings, time zones, language preferences, or environmental variables. Testing the software with different environmental configurations helps identify and mitigate issues related to internationalization, localization, and environmental variability.

Analyzer 208 receives test results 224 from the test machine 204 and determines the validity of the results. The configuration and operation of analyzer 208 is set forth in U.S. patent application Ser. No. 17/386,837, filed on Jul. 28, 2021, and entitled Test System for Data Storage System Performance Testing, owned by the assignee of the present application and incorporated by reference herein in its entirety. In general, analyzer 208 utilizes a random forest classifier to analyze combinations of several key features of the test results along with the hardware specification of the test machine to determine whether the test results are valid.

Profiler 212 receives validation results 228 from the analyzer 208 and determines which test should be run next to provide increased test coverage. The generates a report of the test results 220 and provides this report to regression detector 216, as further described below. The configuration and operation of profiler 212 is set forth in U.S. patent application Ser. No. 18/460,927, filed on Sep. 5, 2023, and entitled System and Method for Data Driven Performance System Testing, owned by the assignee of the present application and incorporated by reference herein in its entirety.

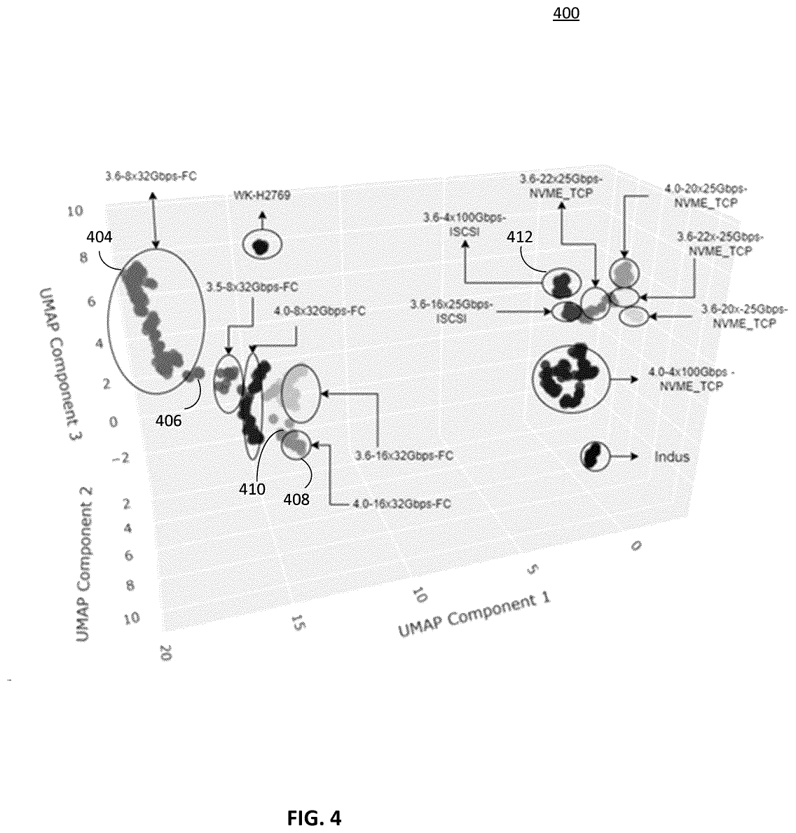

Regression detector 216 receives test results report from profiler 212 and graphs the results into clusters to identify how the results compare to each other to check for possible regressions. The results exhibit variations in parameters (e.g., IOPS and latency) and resources (e.g., machine types), which can make accurately pinpoint regressions, whether they occur between minor versions or major versions, difficult. To overcome this hurdle, historical data from a database of past test results to discern meaningful patterns through analyses of the clustering is analyzed. An example cluster graph 400 is shown in FIG. 4. Using these clusters, tests that deviate from the expected result can be identified. By setting thresholds on how much and how frequently these deviations can occur test personnel can be alerted to possible regressions that need attention.

Shown in graph 400 of FIG. 4 are the results of a number of tests related to multiple different test configurations. The results are plotted based on Uniform Manifold Approximation and Projection for Dimension Reduction (UMAP). Uniform Manifold Approximation and Projection for Dimension Reduction is used for dimensionality reduction of the test results into 3D space in which each dot represents a test. UMAP is a machine learning technique used for nonlinear dimensionality reduction and visualization of high-dimensional data. It works by modeling the manifold structure of the data, preserving local and global relationships between data points while reducing the dimensionality of the dataset. Any number of parameters to be reduced into this 3D space may be identified for a relative comparison of test results (e.g., bandwidth, latency, IOPS (I/O operations), software version, connectivity etc.,). Once the data is collected, it is clustered using the Hierarchical Density-Based Spatial Clustering of Applications with Noise algorithm (HDBSCAN). HDBSCAN is a density-based clustering algorithm used for identifying clusters in high-dimensional data, which is used to identify regions of high density separated by regions of low density. The algorithm begins by constructing a hierarchical representation of the data using a mutual reachability distance metric, which measures the distance between data points relative to their local density. It then employs a condensed tree structure known as the minimum spanning tree (MST) to identify clusters and outliers in the data. HDBSCAN operates by recursively partitioning the data into smaller clusters based on their density and connectivity. It starts by identifying core points, which are data points surrounded by a minimum number of neighboring points within a specified distance threshold. These core points form the initial seeds for clusters. The algorithm then expands each cluster by merging neighboring points that are reachable from the core points, effectively growing the cluster until the density falls below a certain threshold. As described below, based on the clusters formed using these methods, regression of future test results can be detected.

In graph 400, for example, shown generally at 404 is a cluster of multiple test results from tests conducted on a 3.6-8×32GPBS-FC test configuration. Shown generally at 408 is a cluster of multiple test results from tests conducted on a 4.0-16×32GPBS-FC test configuration. Shown generally at 412 is a cluster of multiple test results from tests conducted on a 3.6-4×100Gpbs-ISCSI test configuration. In each of the clusters, each “dot” represents results of a single test and the oval surrounding the cluster represents a threshold set to identify acceptable test results (those within the respective oval) and regressions (those outside of the respective oval). For example, in the cluster identified at 404, most test results are included within the predetermined threshold and are acceptable for testing purposes. However, at least dot 406 represents a regression, in which the test results do not comply with the threshold set for this particular test configuration. Likewise, in the cluster identified at 408, most test results are included within the predetermined threshold and are acceptable for testing purposes. However, at least dot 410 represents a regression, in which the test results do not comply with the threshold set for this particular test configuration. To the contrary, in the cluster identified at 412, all of the associated test results are included within the predetermined threshold and are acceptable for testing purposes.

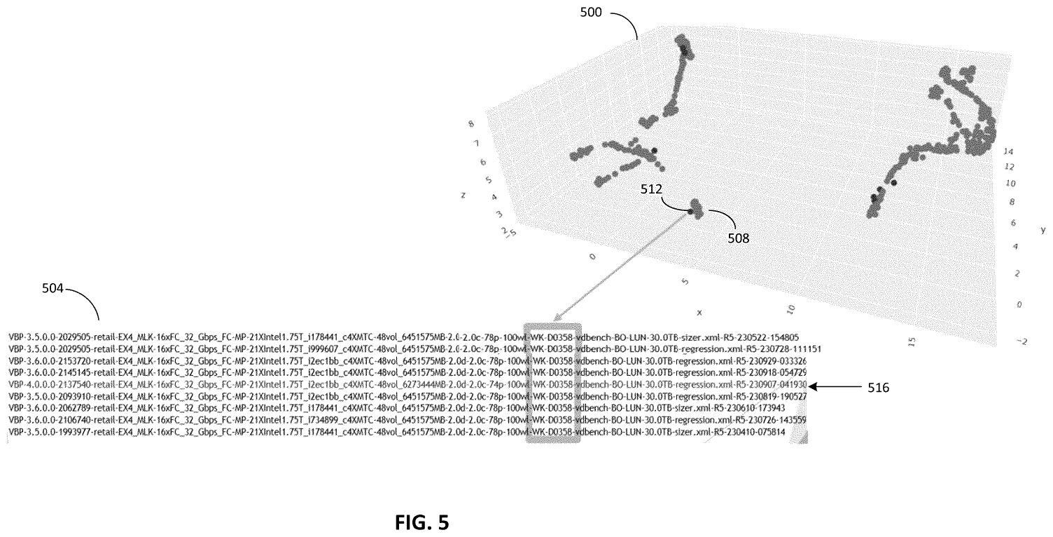

FIG. 5 includes a graph 500 and table 504 associated with an example implementation, both showing information related to tests conducted using test machine 204. Based on a number of tests conducted, cluster 508 is formed as described above. While included within cluster 508, result 512 is determined to be a regression of the test configuration, as identified by the data shown at 516 included in table 504.

The regression detector 216 updates the profiler 212 with this regression information 240 to cause test configurations that exhibit regressions, e.g., 406 and 410, to be retested to validate that the regressions indeed occur. As described above, based on analysis information 228, as well as regression information 240, profiler 212 determines a next test to conduct and instructs, 232, test machine 204 to conduct the next test. The software being tested can then be reviewed and potentially modified to address the regressions. Furthermore, the cluster patterns can be used to predict the behavior of tests, improving test methods and tools.

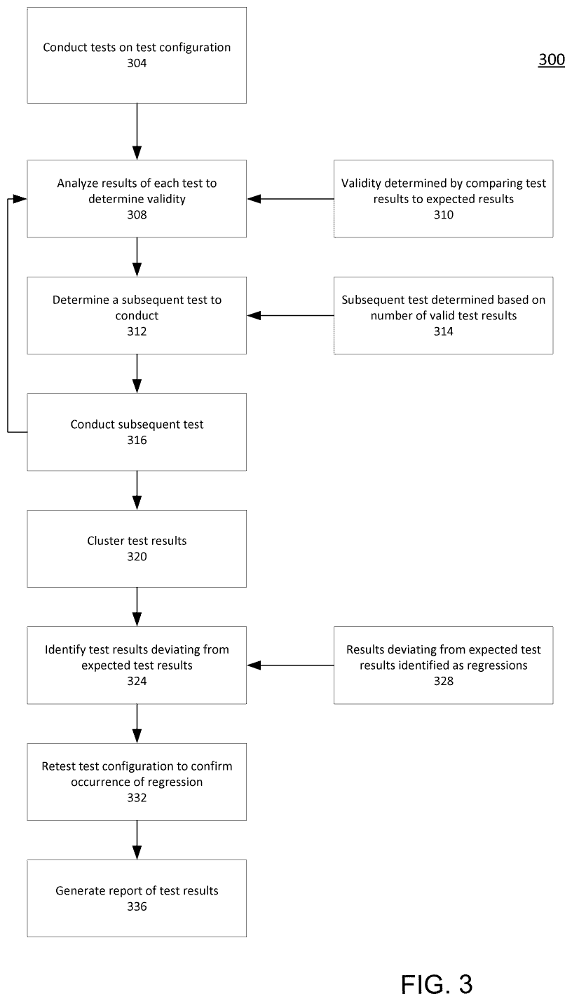

Referring now to FIG. 3, an example flowchart 300 depicts the method carried out in an implementation of the disclosure. At 304, tests are conducted on a test configuration by test machine 204. Analyzer 208 receives test results from test machine 204 and analyzes them to determine the validity of the test results, 308. Test result validity is determined based on a comparison of actual test results to expected results, 310. Validation results 228 are used by profiler 212 to identify a subsequent test to conducted to provide increased test coverage of the test configuration, 312, the subsequent test is determined based on a comparison of the number of valid tests conducted and the number of total tests conducted, 314. The subsequent test is then conducted, 316, and the results of the subsequent test are analyzed by analyzer 208, 308. The 308, 312, 314, 316 loop is repeated until completion of the test, e.g., when sufficient test results have been collected. Test result information is provided to regression detector 216, which graphs the results to show the result cluster for the test configuration 320. Test results deviating from the expected test results (e.g., those falling outside of the threshold) are then identified, 324. The deviating results are identified as regressions, 328. Based on the identified regressions in the test configuration, profiler 208 instructs further testing of the test configuration to confirm the occurrence of the regression, 332. This enables testing personnel to focus on aspects of the test configuration that need attention to address the regressions. A report of the test results is generated by the profiler 208, 336, for further use by the system 200 in subsequent testing scenarios.

Accordingly, implementations of the disclosure include a system and for software performance regression testing and reporting. A plurality of tests are conducted on a test configuration. Test results are analyzed to determine their validity. Based on the validity determination, subsequent test are conducted to increase test coverage of the test configuration. Test results are clustered and deviations from expected results, or regressions, are identified. Information regarding the regressions is used to conduct further testing of the test configuration to enable test personnel to address potential causes of the regressions.

### General:

As will be appreciated by one skilled in the art, the present disclosure may be embodied as a method, a system, or a computer program product. Accordingly, the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present disclosure may take the form of a computer program product on a computer-usable storage medium having computer-usable program code embodied in the medium.

Any suitable computer usable or computer readable medium may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium may include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a transmission media such as those supporting the Internet or an intranet, or a magnetic storage device. The computer-usable or computer-readable medium may also be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to the Internet, wireline, optical fiber cable, RF, etc.

Computer program code for carrying out operations of the present disclosure may be written in an object oriented programming language such as Java, Smalltalk, C++ or the like. However, the computer program code for carrying out operations of the present disclosure may also be written in conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through a local area network/a wide area network/the Internet (e.g., network 14).

The present disclosure is described with reference to flowchart illustrations and/or block diagrams of methods, apparatus (systems) and computer program products according to implementations of the disclosure. It will be understood that each block of the flowchart illustrations and/or block diagrams, and combinations of blocks in the flowchart illustrations and/or block diagrams, may be implemented by computer program instructions. These computer program instructions may be provided to a processor of a general purpose computer/special purpose computer/other programmable data processing apparatus, such that the instructions, which execute via the processor of the computer or other programmable data processing apparatus, create means for implementing the functions/acts specified in the flowchart and/or block diagram block or blocks.

These computer program instructions may also be stored in a computer-readable memory that may direct a computer or other programmable data processing apparatus to function in a particular manner, such that the instructions stored in the computer-readable memory produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide steps for implementing the functions/acts specified in the flowchart and/or block diagram block or blocks.

The flowcharts and block diagrams in the figures may illustrate the architecture, functionality, and operation of possible implementations of systems, methods and computer program products according to various implementations of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustrations, and combinations of blocks in the block diagrams and/or flowchart illustrations, may be implemented by special purpose hardware-based systems that perform the specified functions or acts, or combinations of special purpose hardware and computer instructions.

The terminology used herein is for the purpose of describing particular implementations only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The embodiment was chosen and described in order to best explain the principles of the disclosure and the practical application, and to enable others of ordinary skill in the art to understand the disclosure for various implementations with various modifications as are suited to the particular use contemplated.

A number of implementations have been described. Having thus described the disclosure of the present application in detail and by reference to implementations thereof, it will be apparent that modifications and variations are possible without departing from the scope of the disclosure defined in the appended claims.

What is claimed is:

1. A computer-implemented method, comprising:
conducting a plurality of tests on a test configuration;
analyzing results of each of the plurality of tests to render a validity determination for each of the plurality of tests;
based on the validity determinations, determining a subsequent test to conduct on the test configuration;
conducting the subsequent test on the test configuration, thereby generating a plurality of test results;
clustering the plurality of test results;
identifying test results deviating from an expected test result based on a deviation threshold, resulting in at least one regression from the expected test result; and
retesting the test configuration to confirm the occurrence of the at least one regression.

2. The method of claim 1 wherein the subsequent test is determined based on a number of valid test results compared to a total number of tests performed.

3. The method of claim 2 further comprising utilizing the at least one regression to determine the subsequent test.

4. The method of claim 3 further comprising generating a report of test results.

5. The method of claim 4 further comprising comparing each of the test results to an expected test result to determine acceptable test results.

6. The method of claim 1 further including predicting behavior of the plurality of tests based on clustering patterns.

7. A computing system comprising:
a memory;
a computing environment including a plurality of interconnected computing devices; and
a processor to:
conduct a plurality of tests on a test configuration;
analyze results of each of the plurality of tests to render a validity determination for each of the plurality of tests;
based on the validity determinations, determine a subsequent test to conduct on the test configuration;
conduct the subsequent test on the test configuration, thereby generating a plurality of test results;
cluster the plurality of test results;
identify test results deviating from an expected test result based on a deviation threshold, resulting in at least one regression from the expected test result; and
retest the test configuration to confirm the occurrence of the at least one regression.

8. The system of claim 7 wherein the subsequent test is determined based on a number of valid test results compared to a total number of tests performed.

9. The system of claim 8 further comprising utilizing the at least one regression to determine the subsequent test.

10. The system of claim 9 further comprising generating a report of test results.

11. The system of claim 10 further comprising comparing each of the test results to an expected test result to determine acceptable test results.

12. The system of claim 11 further including predicting behavior of the plurality of tests based on clustering patterns.

13. A computer program product residing on a non-transitory computer readable medium having a plurality of instructions stored thereon which, when executed by a processor, cause the processor to perform operations comprising:
conducting a plurality of tests on a test configuration;
analyzing results of each of the plurality of tests to render a validity determination for each of the plurality of tests;
based on the validity determinations, determining a subsequent test to conduct on the test configuration;
conducting the subsequent test on the test configuration, thereby generating a plurality of test results;
clustering the plurality of test results;
identifying test results deviating from an expected test result based on a deviation threshold, resulting in at least one regression from the expected test result; and
retesting the test configuration to confirm the occurrence of the at least one regression.

14. The method of claim 13 wherein the subsequent test is determined based on a number of valid test results compared to a total number of tests performed.

15. The method of claim 14 further comprising utilizing the at least one regression to determine the subsequent test.

16. The method of claim 15 further comprising generating a report of test results.

17. The method of claim 16 further comprising comparing each of the test results to an expected test result to determine acceptable test results.

18. The method of claim 17 further including predicting behavior of the plurality of tests based on clustering patterns.
